(19) United States
(12) Patent Application Publication
(10) Pub. No.: US 2008/0208696 A1
(43) Pub. Date: Aug. 28, 2008

(54) Point of sale system with web-based back-office

(76) Inventor: Quentin Olson, Poulsbo, WA (US)

Correspondence Address: George O Saile and Assocs, 28 Davis Ave, Poughkeepsie, NY, 12603, US

(21) Appl. No.: 11/710,722

(22) Filed: Feb. 26, 2007

(51) Int. Cl. G06Q 10/00

(52) U.S. Cl. 705/16

(57) ABSTRACT

This invention provides a system and a method for managing a range of businesses. The business operations range from a single branch to a large chain of stores or branches. This invention relates to the managing of the points of sale (POS) with Web-based back-office systems. POS transaction engine terminals are implemented on personal computer, PC hardware using PC software with a relational database. The transaction engine architecture provides cost-effective application customization. Web-based back-office software is implemented on servers. POS and BO systems are monitored and supported via the web using protocol and open software components.

### RELATED PATENT APPLICATION

This application is related to docket number TY2006-002, filed on ______, Ser. No. ______, which is herein incorporated by reference in its entirety.

### BACKGROUND OF THE INVENTION

1. Field of the Invention

This invention relates to a system and an apparatus for managing a range of businesses. The business operations range from a single branch to a large chain of stores or branches.

More particularly this invention relates to the managing of the points of sale (POS) with Web-based back-office systems.

2. Description of Related Art

Currently, point of sale (POS) functions are implemented with custom hardware and/or custom software in the stores or business branches. In addition, custom software is currently used for server functions. Today, servers are required to be located in each store or branch for normal mode operation, and for a backup mode of operation, which is needed if the servers go down. The disadvantages of current practice are that store and branch changes require time and money for software development and testing. In addition, current practice has weak scalability and requires significant technical skill to manage the in-store components. As POS terminals are added within a store or branch or as stores or branches are added, the performance of the overall system degrades. Another disadvantage of current practice is the use of non-standard protocols. Many of these non-standard protocols were implemented before the availability of PC hardware and software and before the wide spread use of universal web protocols. Consequently, current practice includes proprietary protocols which were implemented earlier, but their continued operation is required to enable enterprises to preserve the large investment in proprietary business operations and systems.

U.S. Pat. No. 4,679,154 (Blanford) describes a checkout system for processing purchased merchandise items. The system includes a checkout counter which contains a scanning assembly for scanning a coded label on the purchased item to produce data signals identifying the item purchased, a display member on the counter for displaying the price of the merchandise item purchased, an indicator light and a tone generator located in the display member, a back-office processor for obtaining the price of the merchandise item, and a data terminal device for printing the price of the scanned items on a record member.

U.S. Pat. No. 6,856,970 B1 (Cambell et al.) discloses a financial transaction system which allows clients of a financial institution to use a web-based workstation to interface with a plurality of back-office systems within one or more financial institutions. This system comprises a hub server, a plurality of financial institutions, at least one web server, and at least one database server.

U.S. Pat. No. 6,504,481 B2 (Teller) describes a system, method, and device for monitoring the dispensing of liquids, in particular, beverages dispensed at a bar or restaurant. The system includes an electronic sensor device, data receiver, personal computer, bottle opener/camera system, bar code scanner, point of sale, bar camera, network, Web server, and paging system. The method automatically detects and monitors dispensing events, including detecting the type and amount of liquid, reconciling dispensing events with register ring-ups, recording information, saving video specific to the dispensing event, and sending a page indicating anomalies.

### BRIEF SUMMARY OF THE INVENTION

It is the objective of this invention to provide a system and a method for a system and an apparatus for managing a range of businesses. The business operations range from a single branch to a large chain of stores or branches. This invention relates to the managing of the points of sale (POS) with Web-based back-office systems.

It is further an object of this invention to the manage the points of sale (POS) with Web-based back-office systems.

The objects of this invention are achieved by point of sale system with a web-based back-office system comprised of one or more point of sale (POS) terminals and one or more web servers. The POS terminals and web servers communicate via commonly used, standardized internet protocols. The POS terminals are implemented with personal computer hardware and software using one or more relational databases. The web server is implemented with web server hardware and software, also using one or more relational databases.

### BRIEF DESCRIPTION OF THE DRAWINGS

FIG. 1 shows a high level diagram of this invention.

FIG. 2 gives a high level diagram of a point of sale (POS) terminal.

FIG. 3 gives a core transaction engine/configurable module flow chart.

FIG. 4 is a more detailed diagram of a main embodiment of this invention.

### DETAILED DESCRIPTION OF THE INVENTION

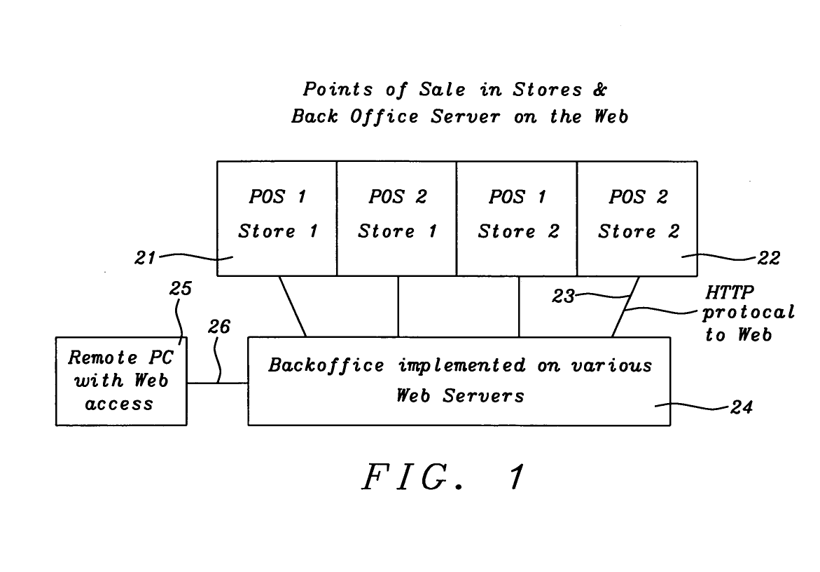

FIG. 1 shows a high level diagram of this invention. Each point of sale (POS) terminal such as POS 21 represents a single cash register in a store, retail location, or business location. POS 21 is in STORE 1 and POS 2 (22) is in store 2. Each POS includes personal computer hardware and software. Additional POS terminals beyond the two shown, as well as additional stores beyond the two shown, are within the scope of the invention. Each POS normally operates with a hardware/software connection 23 to the Internet or Web. However, if the web goes down, the POS terminal continues to operate. There is a loose coupling of the POS to the back office (BO). The POS to BO connection is not required for the basic business functions of the POS. All transaction data is stored in a relational database on the hard drive in the POS.

A relational database stores all of its data inside tables. All operations on data are done on the tables themselves. Some operation produce other tables as the result. A table is a set of rows and columns. Each row is a set of columns with only one value for each. All rows from the same table have the same set of columns, although some columns may have NULL values. A NULL value is an “unknown” value. The rows from a relational table are analogous to a record, and the columns are analogous to a field. Below is an example of a relational table.

| NAME | COMPANY | E_MAIL |
|---|---|---|
| Jane A. Doe | ABC | jad@abc.com |
| Bill X. Smith | XYZ | bxs@xyz.com |

There are two basic operations one can perform on a relational table. The first one is retrieving a subset of its columns. The second is retrieving a subset of its rows. The field names such as company describe the content of the columns of the relational table. The rows delineate the individual records stored in the relational tables.

As transactions are created at a POS a log entry for the newest transaction is also created, this log entry is used to flag if the transaction has been uploaded to the web server. Part of the POS application, the BO interface is continuously running in the background. This component reads the log of transactions. If a transaction needs to be sent, it tries to send it. If the send fails (for example, if the connection to, or the Internet itself, is down), it goes to sleep and tries again later. Additionally, the BO interface requests update from the BO such as new items, price changes, employees, etc. The POS terminals communicate via HTTP protocol (hypertext transfer protocol) 23 with Back-office BO software, which is implemented on web servers 24, which can be located anywhere in the world. In addition, the BO software and data can be viewed from any store employee at any PC who has Internet access 26 and a password.

The POS such as 21 send transaction data to the BO in the form of an HTTP post or communication. The packet 23 sent from the POS to the BO consists of transactions, employee clock, customer add/update, item add/update, promotions and more. Promotions are configured in the back office and associated with items or customers or departments. For example, a promotion may be associated with a customer to implement customer loyalty points or a promotion may be associated with a certain item for a % discount. A client who is the store manager or owner selects a promotion type, associates it with an item, department, etc, then sets the parameters that control how that promotion works. These transaction transmissions between the POS and the BO can be encrypted to insure privacy and security. A typical encryption method is 128 bit SSL (secure sockets layer). A further element of security is that each BO client (individual POS, store or multi-store owner) gets their own instance of a database. When they log into the BO they are attached to their own relational database associated and validated via their user login and password.

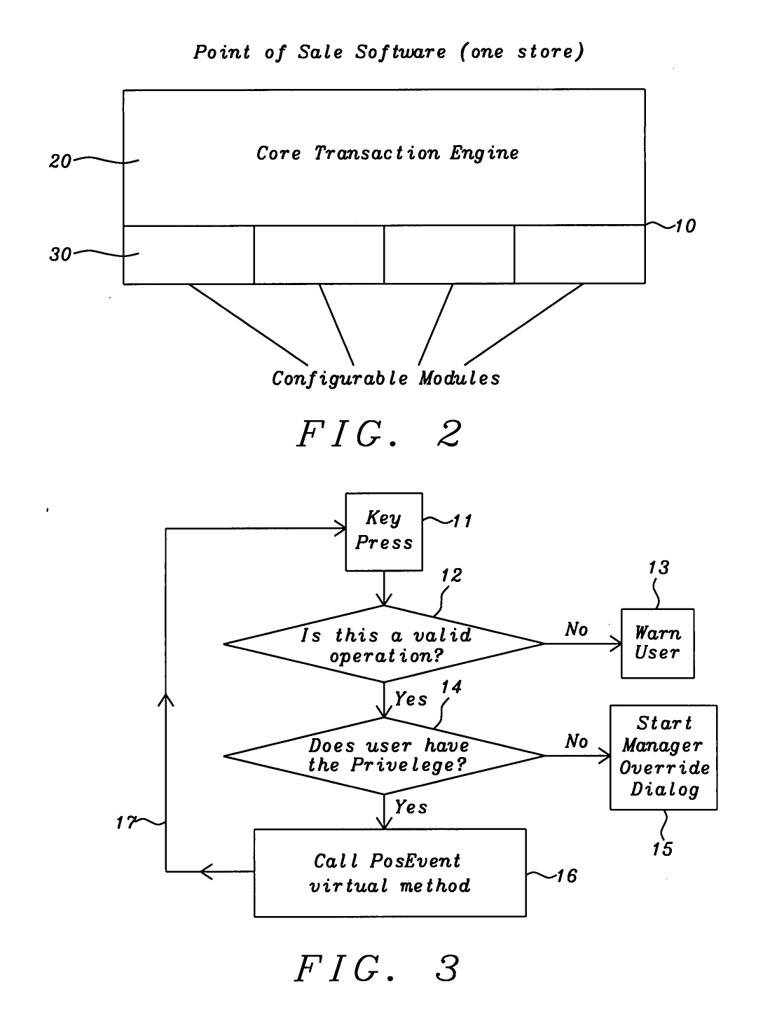

FIG. 2 is a high-level diagram of a POS terminal 10. There is a core transaction Engine 20 which is software which processes all input and output at the POS terminal and invokes the appropriate retail logic. The core transaction engine interfaces with configurable modules 30, which handle the meaning & processing steps of terminal keys required. For example, one business or one store may require a different function performed by the transaction engine when the “Total” key on the POS terminal is pressed. A convenience store may have a different way of computing the summation of taxable items than a restaurant business. These configurable modules allow the POS terminal to be very flexible for use by many different types of stores and businesses.

An example of a promotion which requires some level of configuration information is “Buy 1 and get one free or buy 1 and get the second 50% off”. Typically, these configurable modules are preferably implemented in a computer language such as JAVA which is a combined compile and interpretive language. The use of a JAVA-type object-oriented language allows the dynamic loading of executable configurable modules at run-time to handle things such as different operations of the “Total” key, without changing the other transaction engine modules. Other examples of transaction engine modules are Cash Tender module and Sub-Total module. This allows an efficient, low labor, low cost method of implementing different POS terminal functions.

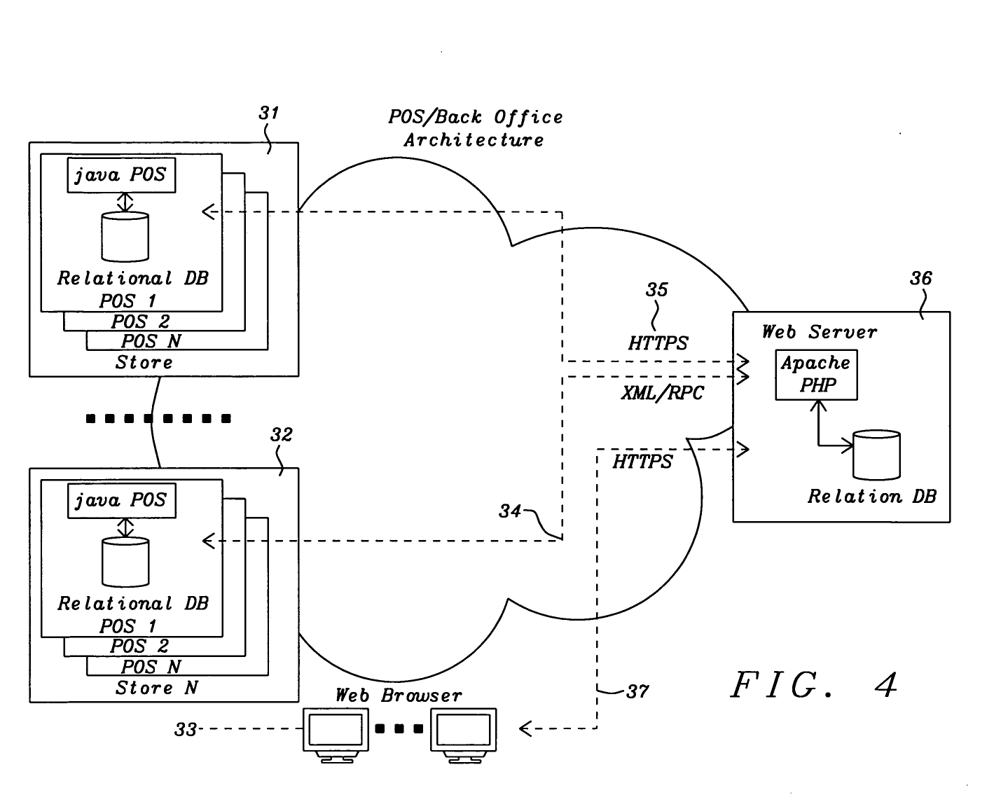

FIG. 3 is a flowchart showing how core transaction software could process a given key press action 11. This key press action 11 could be associated with one of the several keys on a point of sale terminal keyboard, touch screen or touch pad. The core transaction engine asks 12 if this key press action is a valid operation in the current state of the POS machine. If it is not 13, the user is warned via an indicator or message on the POS screen. If it is valid, the core transaction asks if the user has privilege 14. If the user does not have privilege, the transaction engine starts the manager override dialog 15, which asks the user for more information in order to gain access. If the user does have privilege, the transaction engine calls a configurable module 16 called the PosEvent virtual method to handle the required meaning of the key press action. After handling the tasks associated with the key press, the transaction engine returns control 17 back to the key press 11.

The POS transaction is engine designed to allow easy extension of retail business logic through Java dynamic class loading. For example, if an end user wants to modify the way the “Total Key” operates they only need to sub-class an abstract class (PosEvent) and make it available to the Java class loader. No other piece of code requires modification. The system accomplishes this design through a layered architecture. At the bottom is the POS context and electronic journal. These make up the core POS transaction engine by binding together the user context, system parameters and the transaction-processing engine. POS events interact with hardware and the core engine to accomplish the business logic. A hardware layer abstracts the POS events and the physical and virtual devices (key presses, peripheral I/O, input/output). Hardware abstraction classes manage receipt (or spooled) device I/O, interactive I/O (operator prompts) and peripherals that invoke business logic directly (such as cash drawer close). The design utilizes an event model familiar to most GUI application programmers. A listener is registered for events and these events are processed using classes derived from the base (virtual) PosEvent class. The POS event may be invoked or triggered in one of three ways: 1) Directly from a key press/GUI (graphical user interface) button press as shown in FIG. 3, 2) from a device event (credit card swipe, barcode scan, etc.), direct I/O or status change from JavaPOS devices or 3) programmatically from within other PosEvent derived classes or a dialog. An example of a dialog is shown in FIG. 3. A Start Manager override dialog box 15 is shown. This dialog box helps the system to determine if a user should be able to trigger the POS event 16 even though the user does not have “privilege” rights to do so.

FIG. 4 is a more detailed diagram of the main embodiment of this invention. Stores 31, 32 illustrate several POS implemented with Java software using relational databases. The boxes 31, 32 in FIG. 4 show each POS having its own relational database. This architecture offers an element of security. Each BO client, which is an individual POS gets their own instance of a database. When they log into the BO they are attached to their own relational database associated and validated via their user login and password.

Web Server 36 illustrates a BO implemented with Apache PHP using relational databases. PHP (recursive acronym for “PHP: Hypertext Preprocessor”) is a widely-used Open Source general-purpose scripting language that is especially suited for Web development and can be embedded into HTML (hypertext markup language). Apache is a web server currently used in over half of all web sites worldwide. PHP code is different from a script written in other languages like Perl or C. Instead of writing a program with lots of commands to output HTML, one can write an HTML script with some embedded code to do something (ie. to output some text). The PHP code is enclosed in special start and stop tags that allow you to jump into and out of “PHP mode”. What distinguishes PHP from something like client-side JavaScript is that the code is executed on the server. If you were to have HTML script with PHP code imbedded in it, the client would receive the results of running that script, with no way of determining what the underlying code may be. You can even configure your web server to process all your HTML files with PHP. The advantages of using PHP are that it is extremely simple for a newcomer, free to use, but offers many advanced features for a professional programmer. A programmer can jump in and in a short time start writing simple scripts. Remote and local web browsers 33 illustrate a method used by store managers, corporate administrators, or system administers to access and view a company & its store's instantaneous performance from minute to minute. The POS, BO, and Web Browsers all communicate via the Web. 34. The protocols between the POS and Web browsers and BO servers is HTTPs, XMURPC. 35. XML-RPC is a remote procedure call protocol which uses XML to encode its calls and HTTP as a transport mechanism. It is a very simple protocol which defines only a handful of data types and commands.

The key advantages of this point of sale system with a web-based back-office system are as follows. The web and PC architecture both offer full-scalability which results in improved performance and lower cost. There is a lower cost associated with projects developed with the technology of this invention due to the flexibility of easy design changes and well-understood software. There is less training required for programmers and system testers. Projects can draw on the huge talent pool in the open source development community. The invention allows configurable modules for different types of businesses and sales promotions. The invention allows remote monitoring of both the POS and back-office systems from anywhere via the web. There is minimal time required for POS installation, since POS setup is as basic as a home PC setup. Another advantage is that the back-office system can be provided as a service or deployed within a corporation. For example, Software as a Service (SAAS) is a software distribution model in which applications are hosted by a vendor or service provider and made available to customers over a network, typically the Internet. Another advantage of this invention is that the back-office system is maintained in customer centric databases, making it impossible for customers to see other's data. Each BO client (individual POS, store or multi-store owner) gets their own instance of a database. When they log into the BO they are attached to their own relational database associated and validated via their user login and password.

While this invention has been particularly shown and described with Reference to the preferred embodiments thereof, it will be understood by those Skilled in the art that various changes in form and details may be made without Departing from the spirit and scope of this invention.

What is claimed is:

1. A point of sale system with a web-based back-office system, comprising:
one or more point of sale, POS, terminals and
one or more web servers,
wherein said POS terminals and said web servers communicate via internet protocols,
wherein said POS terminals are implemented with personal computer hardware and software using one or more relational databases,
wherein said web server is implemented with web server hardware and software, using one or more relational databases.

2. The point of sale system with a web-based back-office system of claim 1 wherein said POS terminals and said web servers are implemented with executable, configurable software modules, wherein said modules can be easily changed to implement different functions for different businesses.

3. The point of sale system with a web-based back-office system of claim 1, wherein said POS terminals can operate standalone without communicating with said web server.

4. The point of sale system with a web-based back-office system of claim 1, wherein said POS system and said web-based back-office servers are scalable allowing the addition of POS terminals and business locations without degrading system performance.

5. The point of sale system with a web-based back-office system of claim 1, wherein a real-time status of said POS terminals and said back-office web servers is obtained at remote locations via personal computers with browser based web access.

6. A web-based back-office system comprising:
one or more web servers,
wherein said web servers are implemented with web server hardware and software, using one or more relational databases,
wherein said web servers can communicate with point of sale, POS, terminals via internet protocols.

7. The web-based back-office system of claim 6, wherein said web servers are implemented with executable, configurable software modules, wherein said modules can be easily changed to implement different functions for different businesses.

8. The web-based back-office system of claim 6, wherein said web servers allow said POS terminals to operate standalone without communicating with said web servers.

9. The web-based back-office system of claim 6, wherein said web-based back office is scalable allowing the addition of POS terminals and business locations without degrading system performance.

10. The web-based back-office system of claim 6, wherein a real-time status of said POS terminals and/or said back-office system is obtained at remote locations via personal computers with browser based web access.

11. A point of sale POS system comprising,
one or more point of sale, POS, terminals,
wherein said POS terminals can communicate with web servers via internet protocols,
wherein said point of sale terminals are implemented with personal computer hardware and software, using one or more relational databases.

12. The point of sale POS system of claim 11, wherein said POS terminals are implemented with executable, configurable software modules, wherein said modules can be easily changed to implement different functions for different businesses.

13. The point of sale POS system of claim 11, wherein said POS terminals can operate standalone without communicating with said web servers.

14. The point of sale POS system of claim 11, wherein said POS system are scalable allowing the addition of POS terminals and business locations without degrading system performance.

15. The point of sale POS system of claim 11, wherein a real-time status of said POS terminals and/or said back-office web servers is obtained at remote locations via personal computers with browser based web access.

16. A method of providing a point of sale system with a web-based back-office system, comprising the steps of:
providing one or more point of sale, POS, terminals and
providing one or more web servers,
wherein said POS terminals and said web servers communicate via internet protocols,
wherein said POS terminals are implemented with personal computer hardware and software using one or more relational databases,
wherein said web server are implemented with web server hardware and software, using one or more relational databases.

17. The method of providing a point of sale system with a web-based back-office system of claim 16 wherein said POS terminals and said web servers are implemented with executable, configurable software modules, wherein said modules can be easily changed to implement different functions for different businesses.

18. The method of providing a point of sale system with a web-based back-office system of claim 16, wherein said POS terminals can operate standalone without communicating with said web server.

19. The method of providing a point of sale system with a web-based back-office system of claim 16, wherein said POS system and said web-based back-office servers are scalable allowing the addition of POS terminals and business locations without degrading system performance.

20. The method of providing a point of sale system with a web-based back-office system of claim 16, wherein a real-time status of said POS terminals and said back-office web servers is obtained at remote locations via personal computers with browser based web access.

21. A method of providing a web-based back-office system comprising the steps of:
providing one or more web servers,
wherein said web servers are implemented with web server hardware and software, using one or more relational databases,
wherein said web servers can communicate with point of sale, POS, terminals via internet protocols.

22. The method of providing a web-based back-office system of claim 21, wherein said web servers are implemented with executable, configurable software modules, wherein said modules can be easily changed to implement different functions for different businesses.

23. The method of providing a web-based back-office system of claim 21, wherein said web servers allow said POS terminals to operate standalone without communicating with said web servers.

24. The method of providing a web-based back-office system of claim 21, wherein said web-based back-office is scalable allowing the addition of POS terminals and business locations without degrading system performance.

25. The method of providing a web-based back-office system of claim 21, wherein a real-time status of said POS terminals and/or said back-office system is obtained at remote locations via personal computers with browser based web access.

26. A method of providing a point of sale POS system comprising the steps of:
providing one or more point of sale, POS, terminals, wherein said POS terminals can communicate with web servers via internet protocols,
wherein said point of sale terminals are implemented with personal computer hardware and software, using one or more relational databases.

27. The method of providing a point of sale POS system of claim 26, wherein said POS terminals are implemented with executable, configurable software modules, wherein said modules can be easily changed to implement different functions for different businesses.

28. The method of providing a point of sale POS system of claim 26, wherein said POS terminals can operate standalone without communicating with said web servers.

29. The method of providing a point of sale POS system of claim 26, wherein said POS system are scalable allowing the addition of POS terminals and business locations without degrading system performance.

30. The method of providing a point of sale POS system of claim 26, wherein a real-time status of said POS terminals and/or said back-office web servers is obtained at remote locations via personal computers with browser based web access.
